(19) United States
(12) Patent Application Publication
(10) Pub. No.: US 2006/0083602 A1
(43) Pub. Date: Apr. 20, 2006

(54) Blind fastening system

(76) Inventor: Robert J. Lemire, Kings Park, NY (US)

Correspondence Address: ROBERT J. LEMIRE, P.O. BOX 299, KINGS PARK, NY, 11754, US

(21) Appl. No.: 10/967,690

(22) Filed: Oct. 18, 2004

(51) Int. Cl. F16B 21/00

(52) U.S. Cl. 411/344

(57) ABSTRACT

A threadlike retainer cord is used to bring a flat nut inserted through a surface or wall into position with the hole in the surface for a screw to mate with the threads in the nut. This fastening system provides a simple way to fasten objects together without having access to both sides. The retainer cord has elongated ends that are larger than the holes they are put through. The nut is put horizontally through the hole in the wall and rotates 90 degrees after dropping through the hole. The nut is pulled into position over the hole by the cord. In one case the cord goes through a hollow screw while the opposite end is through the threaded hole in the nut. Another possibility is using small holes on both sides of the threaded hole in the nut. The cord is looped through these two holes and aligns the threaded hole in the nut with the hole in the wall when the cord is pulled. This makes it easy to mate a screw with the nut.

### CROSS-REFERENCE TO RELATED APPLICATIONS

(Not Applicable)

### STATEMENT RE: FEDERALLY SPONSORED RESEARCH/DEVELOPMENT

(Not Applicable)

### BACKGROUND OF THE INVENTION

The present invention generally relates to a blind fastening system composed of a fastener, a thin and threadlike retainer cord, and a screw. The nut is inserted through a hole in a surface and held in alignment with the retainer cord for the insertion of a screw for fastening an object onto the surface, or for fastening two objects together.

There are numerous fastening devices that all try to maximize the holding power the fastener exerts onto the back of the surface it is placed onto. The holding power is directly proportional to the amount of surface area that the fastener has on the inside face of the surface. The size of the opening in the surface needed for the insertion of the fastener is another factor in determining the holding power of a fastener. The smaller the hole the less damage the surface has and the stronger the surface is.

This fastening system maximizes the holding power by having almost the entire flat surface of the fastener against the inside face of the surface. It can also be inserted into openings that are almost the same thickness and width of the fastener. For gypsum walls the fastener has a pointed end that allows it to be driven directly through the wall and form a narrow slit of a hole.

In addition to having a maximum of holding power and minimum wall damage, the system is simple to use and inexpensive to manufacture.

### BRIEF SUMMARY OF THE INVENTION

In accordance with the preferred embodiment of the present invention there is provided a blind fastening system composed of a threaded nut, a thin and flexible threadlike retainer cord, and a screw.

A nut with the retainer cord through it is inserted horizontally through a hole in a surface. The nut drops down and becomes parallel to the surface when it passes the inside edge of the hole; however, it is kept in close proximity by the outside portion of the retainer cord. The outside portion of the retained cord is pulled and the nut raises up and becomes aligned with the hole it was inserted into. A screw can then be inserted through an object and used to mate with the nut behind the surface and support the object. The retainer cord can be removed after the screw threads have engaged the nut threads or it can remain. By keeping the retainer cord it allows the object to be removed and a different object affixed to the surface without having to use another nut.

The nut can be tapered or pointed so that it can be driven through a surface thereby eliminating the need for a drill to be used. This has the added benefit of making a very small hole in the surface of the object the nut will be behind. If the object affixed to the surface is to be removed then the repair of the surface is less than if a large hole were used for the fastener.

The amount of holding capability of this fastener is a function of the surface area of the nut and the strength of the surface it is being used on. For metal surfaces the nut need not exceed the width of the hole by much; however, for gypsum walls the length and width of the fastener will be a deciding factor along with the thickness of the wall. This fastener can be used with all thickness' of gypsum walls, and the holding power will differ based on the wall thickness alone.

### BRIEF DESCRIPTION OF THE DRAWINGS

These as well as other features of the present invention, will become more apparent upon reference to the drawings wherein:

FIG. 1 is a plan view of a nut having a threaded nut bounded by two small holes and having a pointed end

FIG. 2 is a sectional view of a nut aligned with a hollow screw for fastening one object to another.

FIG. 3 is a plan view of a nut being aligned behind a hole in a surface by the pulling of the retainer cord

FIG. 4 is section A-A of FIG. 3

### DETAILED DESCRIPTION OF THE INVENTION

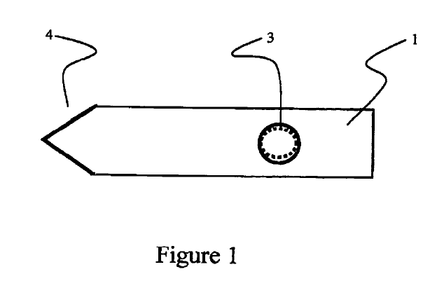

Referring now to the drawings wherein the showings are for purposes of illustrating a preferred embodiment of the present invention only, and not for purposes of limiting the same, FIG. 1 illustrates the nut 1 having threaded hole 3. This nut 1 also has pointed end 4 so that it can be driven through an object.

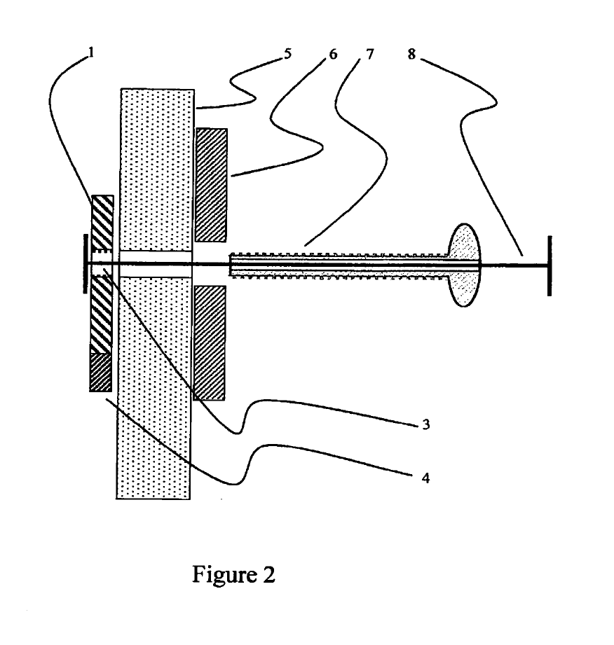

FIG. 2 is a sectional view of nut 1 held in position by flexible retainer cord 8 that is through objects 5 & 6, and also through hollow screw 7 so as to form a system for securing object 6 onto object 5. Retainer cord 8 has ends that are perpendicular to the length of the cord. The cord 8 is flexible and allows the perpendicular ends to fold up parallel to the cord length for insertion into or out of hollow screw 7. The turning of screw 7 into nut threaded hole 3 will fasten object 6 onto object 5. After the screw 7 has engaged the threads of nut 1 the retainer cord 8 can be cut; however, keeping the retainer cord 8 in the screw allows the object to be removed and a different object to be affixed to 5 without having to use another nut 1.

Additional modifications and improvements of the present invention may also be apparent to those of ordinary skill in the art. Thus, the particular combination of parts described and illustrated herein is intended to represent only a certain embodiment of the present invention, and is not intended to serve as limitations of alternative devices within the spirit and scope of the invention.

FIG. 4 is a section view of FIG. 3. Surface 30 has a hole 35 through which nut 31 has been previously inserted into. Nut 31 has holes 32A & 32B with holder cord 34 going through them. Forces F1 and F2 on holder cord 34 are aligning threaded hole 33 within the space of hole 35 in surface 30. This alignment of hole 33 facilitates the ability to insert a screw into it.

Additional modifications and improvements of the present invention may also be apparent to those of ordinary skill in the art. Thus, the particular combination of parts described and illustrated herein is intended to represent only a certain embodiment of the present invention, and is not intended to serve as limitations of alternative devices within the spirit and scope of the invention.

What is claimed is:

1. A blind fastening system comprising a nut having a single flexible retainer cord through the center of the nut and through the center of a hollow screw for supporting the nut in alignment for a hollow screw.

2. The system of claim 1 wherein the threaded nut is pointed so that it can be driven through an object thereby making its own hole.

3. The system of claims I wherein the retainer cord has elongated ends for holding the nut after it is inserted through the hole in the surface thereby allowing the cord to bring the nut into alignment with the hole in the surface.

4. The system of claims 1 wherein one end of the retainer cord is in the threaded hole of the nut and the other end is insertable through a hole along the center of the mating screw, thereby insuring that the screw threads mate with the nut threads.

5. (canceled)

5. The system of claims 1, 2, and 3 wherein the retainer cord goes through small holes on opposite sides of the threaded hole, thereby allowing the cord to bring the threaded hole into alignment with the surface hole for a screw to mate with the threaded hole in the nut.
